(19) United States
(12) Patent Application Publication
(10) Pub. No.: US 2005/0212680 A1
(43) Pub. Date: Sep. 29, 2005

(54) Self-propelled cleaner

(75) Inventor: Naoya Uehigashi, Osaka (JP)

Correspondence Address: Yokoi & Co., U.S.A., Inc., 13700 Marina Pointe Drive #1512, Marina Del Rey, CA, 90292, US

(73) Assignee: Funai Electric Co., Ltd., Osaka (JP)

(21) Appl. No.: 11/078,944

(22) Filed: Mar. 12, 2005

(30) Foreign Application Priority Data
Mar. 25, 2004 (JP) JP2004-089659

(51) Int. Cl. G08B 17/10

(52) U.S. Cl. 340/632; 318/587; 15/21.1; 15/3; 701/23

(57) ABSTRACT

A conventional gas leak alarm system is installed in a fixed place of a kitchen or similar space and just generates an alarm sound. Therefore, only a person which is at home can hear an alarm sound which it generates and even a person at home may not be able to hear it if he/she is away from it. According to this invention, after movement to a standby position at step S440, a system judges whether there is a gas leak, according to the result of detection by a gas sensor. If there is a gas leak, it transmits a text mail to notify a predetermined destination (person) of occurrence of a gas leak and calculates a travel route to a specified first alarm position at steps S452 and S454; after movement along the travel route to the alarm position at step S456, an alarm sounder generates an alarm sound at step S458. After a preset time period, it moves to a specified second alarm position by taking a similar procedure at steps S462 to 466 and continues to generate an alarm sound. Then, it continues shuttling between the first and second alarm positions.

### BACKGROUND OF THE INVENTION

1. Field of the Invention

This invention relates to a self-propelled cleaner comprising a body with a cleaning mechanism and a drive mechanism capable of steering and driving the cleaner.

2. Description of the Prior Art

A system which detects a gas leak and gives warning through a gas alarm device installed in a kitchen or the like has been known. Also a vacuum cleaner with a gas sensor is disclosed in JP-A No. 192280/1993 (Patent document 1) in which a smoke sensor is installed in a suction channel of the cleaner to detect smoking inside it for early gas leak detection.

The above conventional systems have the following problems.

In the former system, the alarm device is installed in a fixed place in the kitchen or the like and such warning was sometimes difficult for a person at home to hear when he/she was distant from the device. Besides, the warning could be heard only by a person at home, or it could not be heard by a person who was away from home.

In the latter system, the user can know occurrence of an abnormality inside it during cleaning but early detection of a fire is impossible.

### SUMMARY OF THE INVENTION

This invention has been made in view of the abovementioned problems and provides a self-propelled cleaner that is capable of cleaning while traveling by itself and can also be used to detect a gas leak utilizing its self-propelling capability.

According to one aspect of this invention, the self-propelled cleaner has a body with a cleaning mechanism, and a drive mechanism capable of steering and driving the cleaner. It includes: a gas sensor which detects a gas leak; an alarm sounder which generates an alarm sound; and a gas leak alarm control processor which acquires the result of detection by the gas sensor in a predetermined standby position and upon detection of gas, controls the drive mechanism to move the cleaner to a predetermined alarm position and enable the alarm sounder to generate an alarm sound in that position.

The system constructed as above has a drive mechanism capable of steering and driving the cleaner and thus it is possible for the cleaner body to travel by itself and perform cleaning. Also, in the system, the gas sensor detects a gas leak and the alarm sounder generates an alarm sound. The gas leak alarm control processor acquires the result of detection by the gas sensor in a predetermined standby position and upon detection of gas, controls the drive mechanism to move the cleaner to a predetermined alarm position and enable the alarm sounder to generate an alarm sound in that position.

In other words, when a cleaner with an inherent self-propelling cleaning capability is given information on a standby position for gas leak detection, it can not only detect a gas leak but also move to an alarm position and generate an alarm sound.

This means that if a gas leak is detected, a person at home can be notified of it early so that necessary measures can be taken.

Although a voice alarm through a speaker is preferable, it is more preferable that a wireless LAN communication device is used to transmit given information to the outside through a wireless LAN and the alarm sounder not only generates a voice alarm but also sends an alarm to the outside through the wireless LAN communication device.

The system constructed as above not only gives a voice alarm but also sends an alarm to the outside through the wireless LAN communication device.

A gas leak may occur while no one is at home. In such a situation, the Internet is used to send an alarm by an e-mail through a wireless LAN. Thus, the user can remotely know occurrence of a gas leak away from home as far as the user, away from home, can receive an e-mail message.

The gas leak sensor in a fixed position can detect gas drifting around it. Therefore, it may not detect a gas leak depending on the air stream condition. On the other hand, according to another aspect of this invention, since the system has a cleaning mechanism, it has a suction motor for vacuuming up dust and the gas sensor lies in the suction channel and the gas leak alarm control processor drives the suction motor to take in ambient air and allow the gas sensor to detect for a gas leak.

The suction motor is driven to take in ambient air and the gas sensor in its suction channel detects for gas, so a gas leak can be detected at an earlier stage.

Some types of gas are likely to stay near the ceiling and others tend to stagnate near the floor. For gas which tends to stay near the ceiling, it is preferable that a communication pipe with openings at both the ceiling and floor sides is installed in a room and an opening in the suction channel of the suction motor can communicate with the floor side opening in the communication pipe.

In the system constructed as above, one end of the communication pipe has an opening at the ceiling side. When the opening at the floor side is communicated with the opening of the suction channel and the suction motor is driven, negative pressure of the suction channel is supplied to the communication pipe and ambient air is sucked in through the opening at the ceiling side. The sucked air passes through the communication pipe and the suction channel and if there is a gas leak, the gas sensor detects gas in the air passing through the suction channel. Therefore, even if leaked gas stagnates near the ceiling, the self-propelled cleaner can detect it.

The gas sensor does not always have to be integral with the self-propelled cleaner and may be a separate unit. According to another aspect of the invention, it is separate from the cleaner body and notifies the gas leak alarm control processor of the result of detection wirelessly.

In the system constructed as above, the gas sensor, which is separate from the body, can be mounted on the ceiling or floor. For gas which tends to stay near the ceiling, it should be mounted on the ceiling while for gas which easily stagnates near the floor, it should be mounted near the floor. Conveniently, it may be mounted near gas cookers. As the gas sensor detects a gas leak, the system notifies the gas leak alarm control processor of the leak wirelessly and the gas leak alarm control processor executes the above control process. The gas sensor may transmit information via radio waves or by optical communications. In the case of radio waves, a wireless LAN may be used; in the case of optical communications, infrared data communications may be used. When the above communication means is adopted, the self-propelled cleaner can use it for communications with external devices and does not require an exclusive communication means.

For movement from a standby position to an alarm position, the drive mechanism must be controlled. According to another aspect of the invention, the gas leak alarm control processor includes: a mapping processor which generates and stores geographical information on a room during traveling around the room by self-propulsion, and acquires, from a marker installed in a given place in the room which outputs positional data on a previously specified location, the positional data during traveling around the room and adds it to the geographical information; a travel route calculation processor which calculates a travel route from the present position to the above position as a specified location; and a movement control processor which enables the travel route calculation processor to calculate a travel route and controls the drive mechanism to move the cleaner along the travel route to the specified location.

In the system constructed as above, the mapping processor generates and stores geographical information on a room during traveling around the room by self-propulsion and acquires, from the marker installed in the given place in the room which outputs positional data on the previously specified location, the positional data and adds it to the geographical information. When the above alarm position is specified as such a specified location, the standby position concerned is included in the geographical information. Since the travel route calculation processor can calculate the travel route from the present position to that specified location, apparently it can calculate the travel route from the present position to that alarm position. Hence, the movement control processor lets the travel route calculation processor calculate the travel route and controls the drive mechanism to enable the cleaner to travel along the travel route and move to the alarm position.

In other words, when a cleaner with an inherent self-propelling cleaning capability is combined with a marker as mentioned above, it can easily acquire data on an alarm position, move to the alarm position and generate an alarm sound.

Although the self-propelled cleaner can generate geographical information in various ways, a user interface which enables the user to recognize the geographical information at a glance will require a means to display a map and a means to receive user instructions, and the like. This would be costly and laborious. Besides, while the self-propelled cleaner is generating geographical information, it does not always travel at a user-specified time in a user-specified place. It would be very inconvenient if the user has to wait to give an instruction until the cleaner reaches a desired position. In contrast, when a marker which provides required positional data is installed, positional data can be preset very easily.

According to another aspect of the invention, the gas leak alarm control processor may be designed to have, on the body, a wall sensor for detecting a surrounding wall surface, and while receiving the result of detection by the wall sensor, be able to control the drive mechanism to move the cleaner along the wall, and acquire positional data from a marker installed along the wall which outputs positional data, and judge whether movement to the alarm position has been completed or not.

Thus, the gas leak alarm control processor has, on the body, a wall sensor for detecting a surrounding wall surface, and while receiving the result of detection by the wall sensor, can control the drive mechanism to move the cleaner along the wall, and acquire positional data from a marker installed along the wall which outputs positional data, and judge whether movement to the position concerned has been completed or not.

In the system constructed as above, since the wall sensor for detecting a surrounding wall surface is mounted on the body, the gas leak alarm control processor can control the drive mechanism to move the cleaner along the wall while receiving the result of detection by the wall sensor. When the marker outputs positional data, if the marker is installed in a standby position along the wall and the system can acquire positional data from the marker while the body is moving along the wall, acquisition of the positional data is interpreted to indicate that movement to the standby position has been completed.

When a function of detecting the presence of a wall is provided, the number of hardware components required for movement along the wall is relatively small. For example, the system may also have a means to make the body turn in an appropriate direction when the wall surface is no longer detected after movement along it. In this case, a marker is used because no specific position is identified. If a marker is found during movement along the wall, the movement may be ended with the marker position as a standby position. Needless to say, the marker may be used not only for a standby position but for a guidepost for access to a final standby position. For instance, if a marker is installed near an entrance to a room, it may be used when deciding whether or not to enter the room.

The cleaning mechanism which is incorporated in the body may be of the suction-type or brush-type or combination-type.

The drive mechanism capable of steering and driving the cleaner enables the cleaner to go forward or backward, or turn to the right (clockwise) or to the left (counterclockwise), or spin on the same spot by controlling individually the driving wheels provided at the right and left sides of the body. In this case, auxiliary wheels may be provided, for example, before and behind the driving wheels. Furthermore, endless belts may be used instead of driving wheels. The number of wheels in the drive mechanism is not limited to two; it may be four, six or more.

According to another aspect of the invention, a self-propelled cleaner has a body with a cleaning mechanism with a suction motor for vacuuming up dust, and a drive mechanism with driving wheels at the left and right sides of the body whose rotation can be individually controlled for steering and driving the cleaner. It includes: a mapping processor which acquires and stores geographical information on a room to be cleaned during traveling around the room for cleaning it and acquires positional data on an alarm position, during traveling around the room, from a marker installed in a given place in the room which outputs positional data on a previously specified location, and adds it to the geographical information; a gas sensor which detects a gas leak; an alarm sounder which generates an alarm sound; a wireless LAN communication device which can transmit given information to the outside through a wireless LAN; a travel route calculation processor which calculates a travel route from the present position to the above specified location; and a gas leak alarm control processor which acquires the result of detection by the gas sensor in a predetermined standby position and upon detection of a gas leak, enables the travel route calculation processor to calculate a travel route and controls the drive mechanism to move the cleaner along the travel route to the specified location and allows the alarm sounder to generate an alarm sound through a speaker and sends an alarm message to the outside through the wireless LAN communication device.

In the system constructed as above, the mapping processor acquires and stores geographical information on a room to be cleaned during traveling around the room for cleaning and acquires, from a marker installed in a given place in the room which outputs positional data on a previously specified position, positional data on an alarm position where an alarm is to be given during traveling around the room, and adds it to the geographical information. The gas leak alarm control processor in a specified standby position acquires the result of detection by the gas sensor, and upon detection of gas, enables the travel route calculation processor to calculate a travel route and controls the drive mechanism to move the body along the travel route to the above specified location and allows the alarm sounder to generate an alarm sound there through a speaker and sends an alarm message to the outside through the wireless LAN communication device.

Taking full advantage of the special feature as a self-propelled machine, upon detection of a gas leak, it is possible to move the body to an alarm position and generate an alarm sound without the need for many additional components.

### BRIEF DESCRIPTION OF THE DRAWINGS

FIG. 1 is a block diagram schematically showing the construction of a self-propelled cleaner according to this invention;

FIG. 2 is a more detailed block diagram of the self-propelled cleaner;

FIG. 3 is a block diagram of a passive sensor for AF;

FIG. 4 illustrates the position of a floor relative to the AF passive sensor and how ranging distance changes when the AF passive sensor is oriented downward obliquely toward the floor;

FIG. 5 illustrates the ranging distance in the imaging range when an AF passive sensor for the immediate vicinity is oriented downward obliquely toward the floor;

FIG. 6 illustrates the positions and ranging distances of individual AF passive sensors;

FIG. 7 is a flowchart showing a travel control process;

FIG. 8 is a flowchart showing a cleaning travel process;

FIG. 9 shows a travel route in a room;

FIG. 10 shows the composition of an optional unit;

FIG. 11 shows the external appearance of a marker;

FIG. 12 is a flowchart showing a mapping process;

FIG. 13 illustrates how mapping is done;

FIG. 14 illustrates how geographical information on each room is linked after mapping;

FIG. 15 is a flowchart showing a gas leak detection process; and

FIG. 16 is a plan view showing a travel route in a room to warn of a gas leak.

### DESCRIPTION OF THE PREFERRED EMBODIMENTS

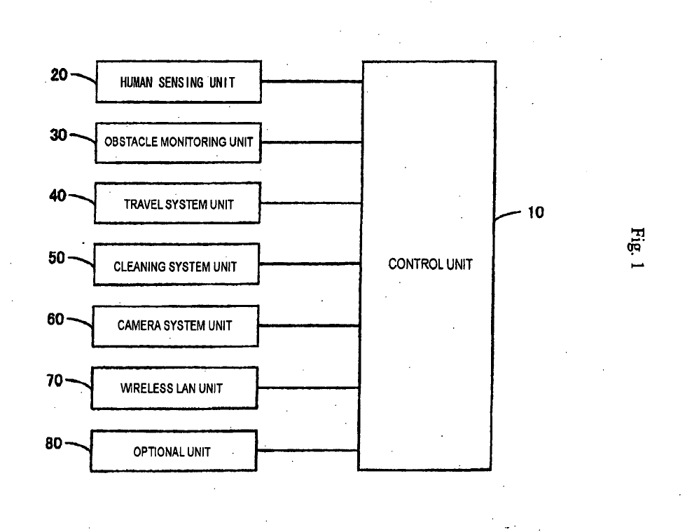

As shown in FIG. 1, according to this invention, the cleaner includes a control unit 10 to control individual units; a human sensing unit 20 to detect a human or humans around the cleaner; an obstacle monitoring unit 30 to detect an obstacle or obstacles around the cleaner; a traveling system unit 40 for traveling; a cleaning system unit 50 for cleaning; a camera system unit 60 to take a photo of a given area; a wireless LAN unit 70 for wireless connection to a LAN; and an optional unit 80 including an additional sensor and the like. The body of the cleaner has a low profile and is almost cylindrical.

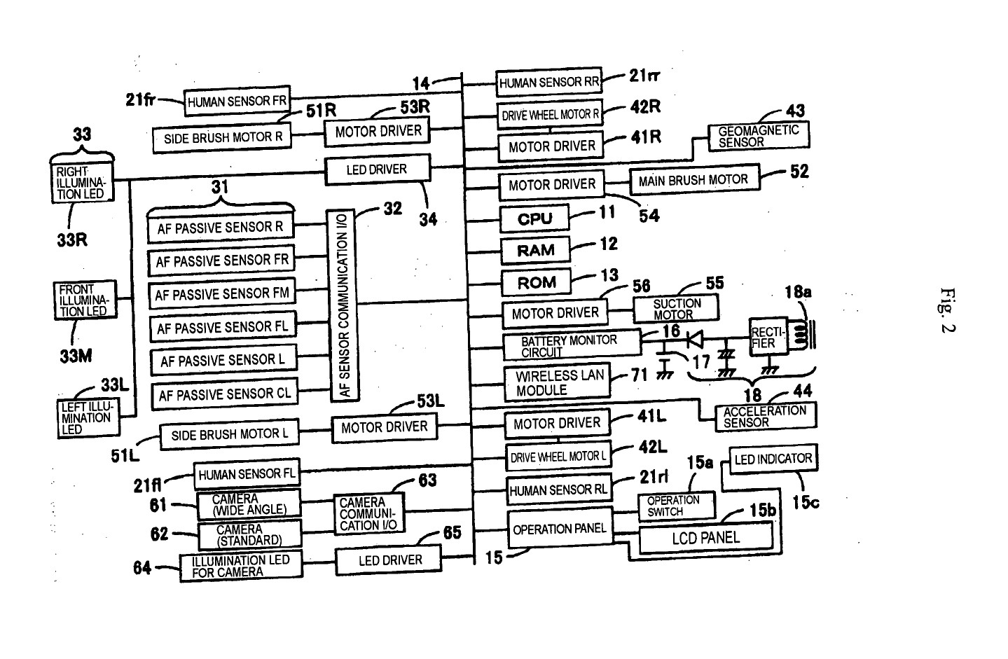

As shown in FIG. 2, a block diagram showing the electrical system configuration for the individual units, a CPU 11, a ROM 13, and a RAM 12 are interconnected via a bus 14 to constitute a control unit 10. The CPU 11 performs various control tasks using the RAM 12 as a work area according to a control program stored in the ROM 13 and various parameter tables. The control program will be described later in detail.

The bus 14 is equipped with an operation panel 15 on which various types of operation switches 15a, a liquid crystal display panel 15b, and LED indicator 15c are provided. Although the liquid crystal display panel is a monochrome liquid crystal panel with a multi-tone display function, a color liquid crystal panel or the like may also be used.

This self-propelled cleaner has a battery 17 and allows the CPU 11 to monitor the remaining amount of the battery 17 through a battery monitor circuit 16. The battery 17 is equipped with a charge circuit 18 that charges the battery with electric power supplied in a non-contact manner through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1), two of which are disposed obliquely at the left and right sides of the front of the body and the other two at the left and right sides of the rear of the body. Each human sensor 21 has an infrared light-receiving sensor that detects the presence of a human based on the amount of infrared light received. When the human sensor detects an irradiated object which changes the amount of infrared light received, the CPU 11 obtains the detection of the human sensor 21 via the bus 14 to change the status for output. In other words, the CPU 11 obtains the status of each of the human sensors 21fr, 21rr, 21f1, and 21r1 at each predetermined time and detects the presence of a human in front of the human sensor 21fr, 21rr, 21f1, or 21r1 by a change in the status.

Although the human sensors described above detect the presence of a human based on changes in the amount of infrared light, the human sensors are not limited to this type. For example, if the CPU's processing capability is increased, it is possible to take a color image of a target area, identify a skin-colored area that is characteristic of a human body and detect the presence of a human based on the size of the area and/or change.

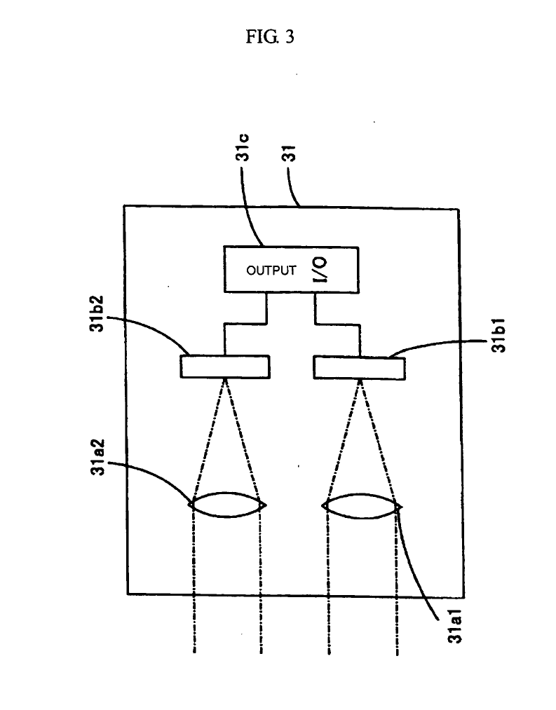

The obstacle monitoring unit 30 consists of a passive sensor unit 31 composed of ranging sensors for auto focus (hereinafter called AF) (31R, 31FR, 31FM, 31FL, 31L, 31CL); an AF sensor communication I/O 32 as a communication interface to the passive sensor unit 31; illumination LEDs 33; and an LED driver 34 to supply driving current to each LED. First, the construction of the AF passive sensor unit 31 will be described. FIG. 3 schematically shows the construction of the AF passive sensor unit 31. It includes a biaxial optical system consisting of almost parallel optical systems 31a1 and 31a2; CCD line sensors 31b1 and 31b2 disposed approximately in the image focus positions of the optical systems 31a1 and 31a2 respectively; and an output I/O 31c to output image data taken by each of the CCD line sensors 31b1 and 31b2 to the outside.

The CCD line sensors 31b1 and 31b2 each have a CCD sensor with 160 to 170 pixels and can output 8-bit data representing the amount of light for each pixel. Since the optical system is biaxial, the discrepancy between two formed images varies depending on the distance, which means that it is possible to measure a distance based on a difference between data from the CCD line sensors 31b1 and 31b2. As the distance decreases, the discrepancy between formed images increases, and vice versa. Therefore, an actual distance is determined by scanning data rows (4-5 pixels/row) in output image data, finding the difference between the address of an original data row and that of a discovered data row, and then referencing a difference-to-distance conversion table prepared in advance.

The AF passive sensors 31FR, 31FM, and 31FL are used to detect an obstacle in front of the cleaner while the AF passive sensors 31R and 31L are used to detect an obstacle on the right or left ahead in the immediate vicinity. The AF passive sensor 31CL is used to detect a distance up to the ceiling ahead.

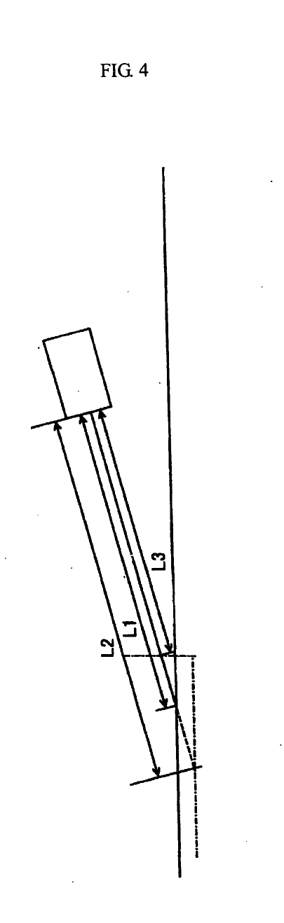

FIG. 4 shows the principle under which the AF passive sensor unit 31 detects an obstacle in front of the cleaner or on the immediate right or left ahead. The AF passive sensor unit 31 is oriented obliquely toward the surrounding floor surface. If there is no obstacle on the opposite side, the ranging distance covered by the AF passive sensor unit 31 in the almost whole imaging range is expressed by L1. However, if there is a floor level difference as indicated by alternate long and short dash line in the figure, the ranging distance is expressed by L2. Namely, an increase in the ranging distance suggests the presence of a floor level difference. If there is a floor level rise as indicated by alternate long and two dashes line, the ranging distance is expressed by L3. If there is an obstacle, the ranging distance is calculated as the distance to the obstacle as when there is a floor level rise, and it is shorter than the distance to the floor.

In this embodiment, when the AF passive sensor unit 31 is oriented obliquely toward the floor surface ahead, its imaging range is approx 0.10 cm. Since this self-propelled cleaner has a width of 30 cm, the three AF passive sensors 31FR, 31FM and 31FL are arranged at slightly different angles so that their imaging ranges do not overlap. This arrangement allows the three AF passive sensors 31FR, 31FM and 31FL to detect an obstacle or floor level difference in a 30 cm wide area ahead of the cleaner. The detection area width varies depending on the sensor model and position, and the number of sensors should be determined according to the actually required detection area width.

Regarding the AF passive sensors 31R and 31L which detect an obstacle on the immediate right and left ahead, their imaging ranges are vertically oblique to the floor surface. The AF passive sensor 31R is mounted at the left side of the body so that a rightward area beyond the width of the body is shot across the center of the body from the immediate right and the AF passive sensor 31L is mounted at the right side of the body so that a leftward area beyond the width of the body is shot across the center of the body from the immediate left.

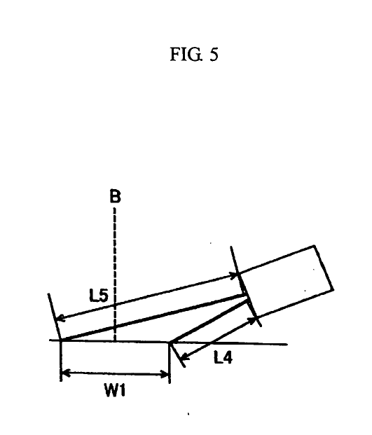

If the left and right sensors should be located so as to cover the leftward and rightward areas just before them respectively, they would have to be sharply angled with respect to the floor surface and the imaging range would be very narrow. As a consequence, more than one sensor would be needed on each side. For this reason, the left and right sensors are arranged to cover the rightward and leftward areas respectively in order to obtain a wider imaging range with a smaller number of sensors. The CCD line sensors are arranged vertically so that the imaging range is vertically oblique, and as shown in FIG. 5, the imaging range width is expressed by W1. Here, L4, distance to the floor surface on the right of the imaging range, is short and L5, distance to the floor surface on the left, is long. The imaging range portion up to the border line is used to detect a floor level difference or the like and the imaging range portion beyond the border line is used to detect a wall, where the border line of the body BD side is expressed by dashed line B in the figure.

The AF passive sensor 31CL, which detects a distance to the ceiling ahead, faces the ceiling. Usually, the distance from the floor surface to the ceiling which is detected by the AF passive sensor 31CL is constant but as it comes closer to a wall surface, it covers not the ceiling but the wall surface and the ranging distance becomes shorter. Hence, the presence of a wall can be detected more accurately.

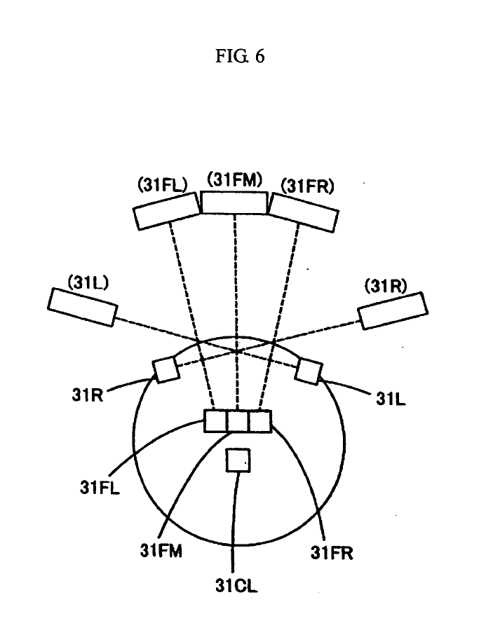

FIG. 6 shows how the AF passive sensors 31R, 31FR, 31FM, 31FL, 31L and 31CL are located on the body BD where the respective floor imaging ranges covered by the sensors are represented by the corresponding code numbers in parentheses. The ceiling imaging range is omitted here.

The cleaner has the following white LEDs: a right illumination LED 33R, a left illumination LED 33L and a front illumination LED 33M to illuminate the images from the AF passive sensors 31R, 31FR, 31FM, 31FL and 31L; and an LED driver 34 supplies a driving current to illuminate the images according to an instruction from the CPU11. Therefore, even at night or in a dark place (under the table, etc), it is possible to acquire image data from the AF passive sensor unit 31 effectively.

The traveling system unit 40 includes: motor drives 41R, 41L; driving wheel motors 42R, 42L; and a gear unit (not shown) and driving wheels driven by the driving wheel motors 42R and 42L. A driving wheel is provided on each side (right and left) of the body. In addition, a free rolling wheel without a drive source is attached to the center bottom of the front side of the body. The rotation direction and angle of the driving wheel motors 42R and 42L can be accurately controlled by the motor drivers 41R and 41L which output drive signals according to an instruction from the CPU 11. From output of rotary encoders integral with the driving wheel motors 42R and 42L, the actual driving wheel rotation direction and angle can be accurately detected. Alternatively, the rotary encoders may not be directly connected with the driving wheels but a driven wheel which can rotate freely may be located near a driving wheel so that the actual amount of rotation can be detected by feedback of the amount of rotation of the driven wheel even if the driving wheel slips. The traveling system unit 40 also has a geomagnetic sensor 43 so that the traveling direction can be determined according to the earth magnetism. An acceleration sensor 44 detects the acceleration speed in the X, Y and Z directions and outputs the detection result.

The gear unit and driving wheels may be embodied in any form and they may use circular rubber tires or an endless belt to be driven.

The cleaning mechanism of the self-propelled cleaner consists of: side brushes located forward at both sides which gather dust beside each side of the body in the advance direction and bring it toward the center of the body; a main brush which scoops the gathered dust in the center; and a suction fan which takes the dust scooped by the main brush into a dust box by suction. The cleaning system unit 50 consists of: side brush motors 51R and 51L and a main brush motor 52; motor drivers 53R, 53L and 54 for supplying driving power to the motors; a suction motor 55 for driving the suction fan; and a motor driver 56 for supplying driving power to the suction motor. The CPU 11 appropriately controls cleaning operation with the side brushes and main brush depending on the floor condition and battery condition or a user instruction.

The camera system unit 60 has two CMOS cameras 61 and 62 with different viewing angles which are mounted on the front side of the body BD at different angles of elevation. A camera communication I/O 63 which gives the camera 61 or 62 an instruction to take a photo and outputs the photo image. In addition, it has a illumination LED for camera 64 composed of 15 white LEDs oriented toward the direction in which the cameras 61 and 62 take photos, and an LED driver 65 for supplying driving power to the LEDs.

The wireless LAN unit 70 has a wireless LAN module 71 so that the CPU 11 can be connected with an external LAN wirelessly in accordance with a prescribed protocol. The wireless LAN module 71 assumes the presence of an access point (not shown) and the access point should be connectable with an external wide area network (for example, the Internet) through a router. Therefore, ordinary mail transmission and reception through the Internet and access to websites are possible. The wireless LAN module 71 is composed of a standardized card slot and a standardized wireless LAN card to be connected with the slot. Needless to say the card slot may be connected with another type of standardized card.

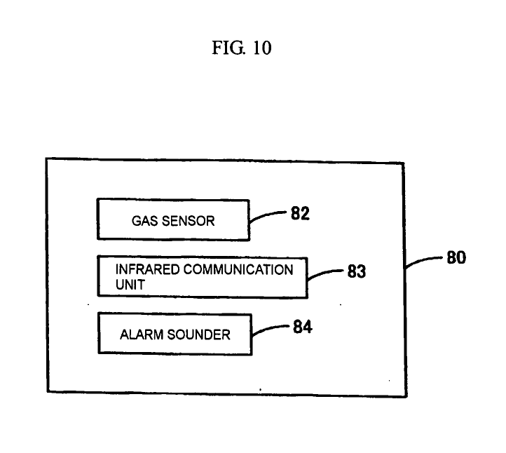

The optional unit 80 includes additional sensors and as shown in FIG. 10, in this embodiment, it has a gas sensor 82, an infrared communication unit 83 and an alarm sounder 84. The gas sensor 82 is a sensor in a suction channel which detects for a gas leak. Such sensors are connected to the bus 14 and the CPU 11 can acquire the result of detection by each sensor. The infrared communication unit 83 can receive an infrared signal as encoded positional data sent from a marker (stated later) and decode the positional data and send it to the CPU 11. The alarm sounder 84 warns a person at home of a gas leak and generates an alarm sound through its speaker. Here, a voice alarm is desirable but a siren or buzzer sound is acceptable.

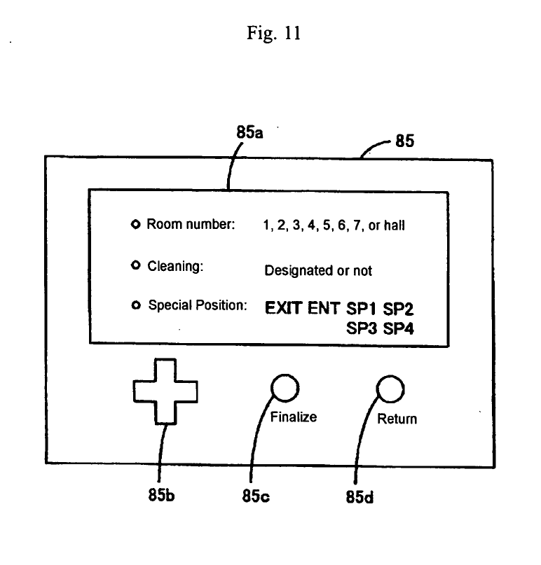

FIG. 11 shows the appearance of the marker 85 which has a liquid crystal display panel 85a, a cross key 85b, an Finalizing key 85c and a Return key 85d on its external face. Inside it are a one-chip microcomputer, an infrared transmission/reception unit, a battery and so on. The one-chip microcomputer controls the display content on the liquid crystal display panel 85a according to the operation of the Finalizing key 85c or Back key and generates parameters in response to key operation to allow the infrared transmission/reception unit to output positional data depending on the parameters. In this embodiment, the following parameters are available: room numbers “1 to 7 or hall”; cleaning “yes” and “no”; and special locations “EXIT” (exit), “ENT” (entrance), “SP1” (special location 1), “SP2” (special location 2), “SP3” (special location 3), and “SP4” (special location 4). In the embodiment below, special location 1 represents a standby position as a gas leak detection point; location 2 a position where an alarm is given for the first time (first alarm position); and location 3 a position where an alarm is given for the second time (second alarm position). A flowchart required to specify these parameters does not require special expertise and can be prepared by a person with ordinary knowledge in the art.

Next, how the above self-propelled cleaner works will be described.

(1) Travel Control and Cleaning Operation

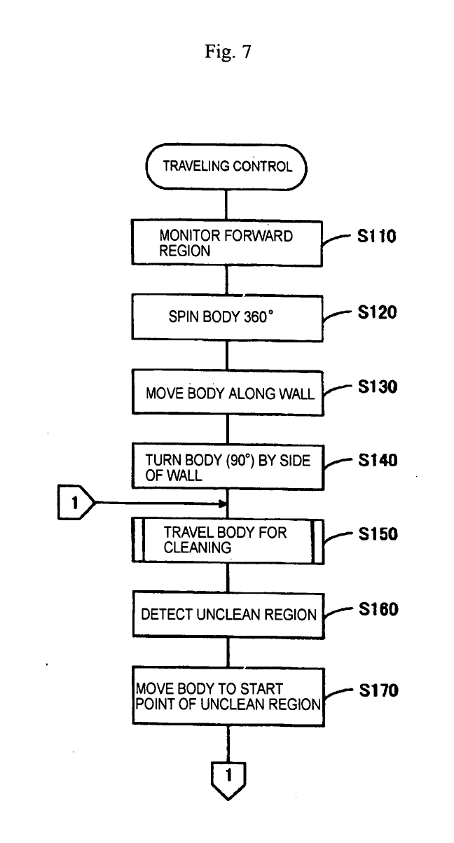

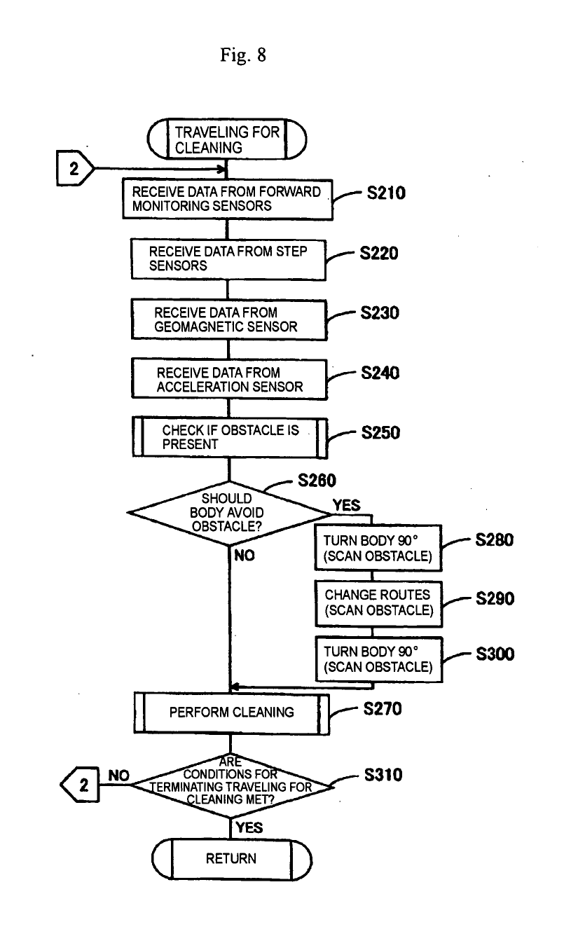

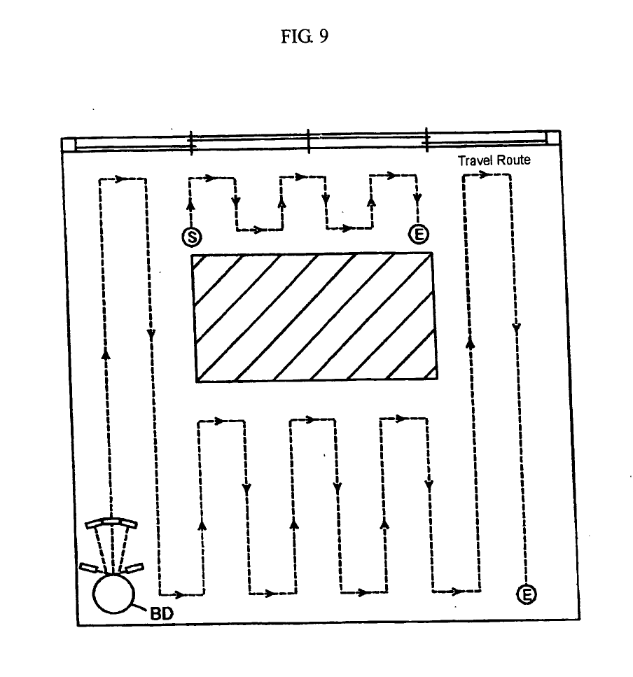

FIGS. 7 and 8 are flowcharts which correspond to a control program which is executed by the CPU 11; and FIG. 9 shows a travel route on which this self-propelled cleaner moves under the control program.

When the power is turned on, the CPU 11 begins travel control as shown in FIG. 7. At step S110, it receives the results of detection by the AF passive sensor unit 31 and monitors a forward region. In monitoring the forward region, reference is made to the results of detection by the AF passive sensors 31FR, 31FM and 31F; and if the floor surface is flat, the distance L1 to the floor surface (located downward in an oblique direction as shown in FIG. 4) is obtained from an image thus taken. Whether the floor surface in the forward region corresponding to the body width is flat or not is decided based on the results of detection by the AF passive sensors 31FR, 31FM and 31FL. However, at this moment, no information on the space between the body's immediate vicinity and the floor surface areas facing the AF passive sensors 31FR, 31FM and 31FL is not obtained so the space is a dead area.

At step S120, the CPU 11 orders the driving wheel motors 42R and 42L to rotate in different directions by equal amount through the motor drivers 41R and 41L respectively. As a consequence, the body begins turning on the spot. The rotation amount of the drive motors 42R and 42L required for 360-degree turn (spin turn) on the same spot is known and the CPU 11 informs the motor drivers 41R and 41L of that required rotation amount.

During this spin turn, the CPU 11 receives the results of detection by the AF passive sensors 31R and 31L and judges the condition of the immediate vicinity of the body. The above dead area is almost covered (eliminated) by the results of detection obtained during this spin turn, and if there is no floor level difference or obstacle there, it is confirmed that the surrounding floor surface is flat.

At step 130, the CPU 11 orders the driving wheel motors 42R and 42L to rotate by equal amount through the motor drivers 41R and 41L respectively. As a consequence, the body BD begins moving straight ahead. During this straight movement, the CPU 11 receives the results of detection by the AF passive sensors 31FR, 31FM and 3FL and the body advances while checking whether there is an obstacle ahead. The above dead area is almost covered by the detection made during this spin turn. When a wall surface as an obstacle ahead is detected, the body stops short of the wall surface by a prescribed distance.

At step S140, the body turns clockwise by 90 degrees. The prescribed distance short of the wall at step S130 corresponds to a distance that the body BD can turn without colliding the wall surface and the AF passive sensors 31R and 31L can monitor their immediate vicinity and rightward and leftward areas beyond the body width. In other words, the distance should be such that when the body turns 90 degrees at step S140 after it stops according to the results of detection by the AF passive sensors 31FR, 31FM and 31FL at step S130, the AF passive sensor 31L can at least detect the position of the wall surface. Before it turns 90 degrees, the condition of its immediate vicinity should be checked according to the results of detection by the AF passive sensors 31R and 31L. FIG. 9 is a plan view which shows the cleaning start point (in the left bottom corner of the room as shown) which the body has thus reached.

There are various other methods of reaching the cleaning start point. If the body should turn only clockwise 90 degrees in contact with the wall surface, cleaning would begin midway on the first wall. If the body reaches the optimum position in the left bottom corner as shown in FIG. 9, it is also desirable to control its travel so that it turns counterclockwise 90 degrees in contact with the wall surface and advances until it touches the front wall surface, and upon touching the front wall surface, it turns 180 degrees.

At step S150, the body travels for cleaning. FIG. 8 is a flowchart which shows cleaning travel steps in detail. Before advancing or moving forward, the CPU 11 receives the results of detection by various sensors at steps S210 to S240. At step S210, it receives forward monitor sensor data (specifically the results of detection by the AF passive sensors 31FR, 31FM, 31FL and 31CL) which is used to judge whether or not there is an obstacle or wall surface ahead in the traveling area. Forward monitoring here includes monitoring of the ceiling in a broad sense.

At step S220, the CPU 11 receives floor level difference sensor data (specifically the results of detection by the AF passive sensors 31R and 31L) which is used to judge whether or not there is a floor level difference in the immediate vicinity of the body in the traveling area. Also, while the body moves along a wall surface or obstacle, the distance to the wall surface or obstacle is measured in order to judge whether or not it is moving in parallel with the wall surface or obstacle.

At step 230, the CPU 11 receives geomagnetic sensor data (specifically the result of detection by the geomagnetic sensor 43) which is used to judge whether or not there is any change in the traveling direction of the body which is moving straight. For example, the angle of earth magnetism at the cleaning start point is memorized and if an angle detected during traveling is different from the memorized angle, the amounts of rotation of the left and right driving wheel motors 42R and 42L are slightly differentiated to correct the moving direction to restore the original angle. If the angle becomes larger than the original angle of earth magnetism (change from 359 degrees to 0 degree is an exception), it is necessary to correct the moving direction leftward. Hence, an instruction is given to the motor drivers 41R and 41L to make the amount of rotation of the right driving wheel motor 42R slightly larger than that of the left driving wheel motor 42L.

At step S240, the CPU 11 receives acceleration sensor data (specifically the result of detection by the acceleration sensor 44) which is used to check the traveling condition. For example, if the direction of acceleration is almost constant just after start of straight movement, it is thought to suggest a normal travel, but if a change in the direction of acceleration is detected, it is suspected that one driving wheel motor is not driven. If a detected acceleration velocity is out of the normal range, a fall from a bump or an overturn is suspected. If a considerable backward acceleration is detected, collision against an obstacle ahead is suspected. Although there is no direct acceleration control function (for example, a function to keep a desired acceleration velocity by input of an acceleration value or achieve a desired acceleration velocity based on integration), acceleration data is effectively used to detect an abnormality.

At step S250, the presence of an obstacle is judged based on the results of detection by the AF passive sensors 31FR, 31FM, 31CL, 31FL, 31R and 31L which the CPU 11 have received at steps S210 and S220. An obstacle judgment is made for each subarea of the forward region, ceiling and immediate vicinity. Here the forward region refers to an area ahead where detection for an obstacle or wall surface is made; and the immediate vicinity refers to an area where detection for a floor level difference is made or the condition of areas on the left and right of the body beyond the traveling width is checked (presence of a wall, etc). The ceiling here refers to an area where a detection is made, for example, for a door lintel underneath the ceiling which leads to a hall and might cause the body to go out of the room.

At step S260, the system evaluates the results of detection by the sensors comprehensively to decide whether to escape or not. As far as it is unnecessary to escape, a cleaning process at step S270 is carried out. The cleaning process refers to a process that dust is sucked in while the side brushes and main brush are rotating. Concretely, an instruction is issued to the motor drivers 53R, 53L, 54 and 56 to drive the motors 51R, 51L, 52 and 55. Obviously the same instruction is always given during traveling and when the conditions to end cleaning travel are met, the body stops traveling.

On the other hand, if it is decided that the body should escape, it turns clockwise 90 degrees at step S280. This is a 90-degree turn on the same spot which is achieved by giving an instruction to the driving wheel motors 42R and 42L through the motor drivers 41R and 41L respectively to turn in different directions by the amount necessary for the 90-degree turn. Here, the right driving wheel should turn backward and the left driving wheel should turn forward. During the turn, the CPU 11 receives the results of detection by the AF passive sensors 31R and 31L as floor level difference sensors and checks for an obstacle. When an obstacle ahead is detected and the body turns clockwise 90 degrees, if the AF passive sensor 31R does not detect a wall ahead on the right in the immediate vicinity, it may be considered to have simply touched a forward wall, but if a wall surface ahead on the right in the immediate vicinity is still detected even after the turn, the body may be considered to get caught in a corner. If neither of the AF passive sensors 31R and 31L detects an obstacle ahead in the immediate vicinity during 90-degree turn, it can be thought that the body has not touched a wall but there is a small obstacle.

At step S290, the body advances to turn while scanning for an obstacle. It touches the wall surface and turns clockwise 90 degrees, then advances. If it has stopped short of the wall, the distance of the advance is almost equal to the body width. After advance by that distance, the body turns clockwise 90 degrees again.

During the above movement, the forward region and leftward and rightward areas ahead are always scanned for an obstacle and the result of this monitoring scan is memorized as information on the presence of an obstacle in the room.

As explained above, a 90-degree clockwise turn is made twice. If the body should turn clockwise 90 degrees upon detection of a next wall ahead, it would return to its original position. Therefore, after it turns clockwise 90 degrees twice, it should turn counterclockwise twice and after that, counterclockwise, namely in alternate directions. This means that it should turn clockwise at an odd-numbered time of escape motion and counterclockwise at an even-numbered time of escape motion.

The system continues traveling for cleaning while scanning the room in a zigzag pattern and avoiding an obstacle as described so far. Then at step S310, whether or not it has reached the end of the room is decided. When, after the second turn, the body has advanced along the wall and has detected an obstacle ahead, or when it enters an area where it has already traveled, it is decided that the body has reached the cleaning travel end point. In other words, the former situation is a condition which occurs after the last end-to-end travel in the zigzag movement; and the latter situation is a condition that an area left uncleaned is found and cleaning travel is started again.

If either of these conditions is not met, the system goes back to step S210 and repeats the abovementioned steps. If either of the conditions is met, the system finishes the cleaning travel subroutine and returns to the process of FIG. 7.

After returning to the process of FIG. 7, at step S160, the system judges from the collected information on the travel route and its surroundings as to whether or not there is any area left uncleaned. If an uncleaned area is found, the body moves to the start point of the uncleaned area at step S170 and the system returns to step S150 and starts cleaning travel again.

Even if there are more than one uncleaned area here and there, each time a condition to end cleaning travel is met, detection for an uncleaned area is repeated as described above until there is no uncleaned area.

(2) Mapping

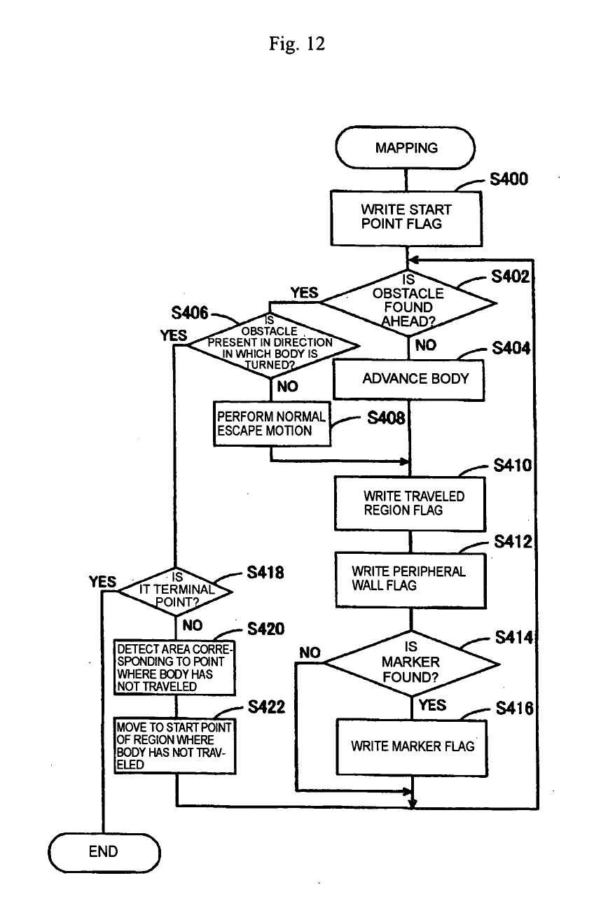

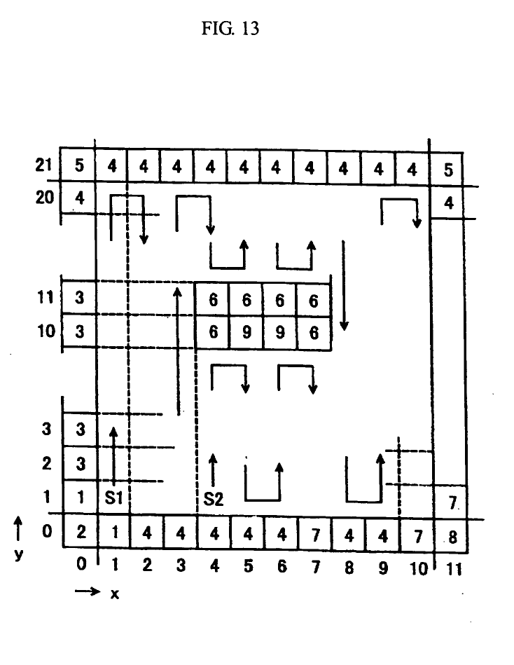

Various methods of detection for an uncleaned area are available. This embodiment adopts a method as illustrated in FIGS. 12 and 13.

FIG. 12 is a flowchart of mapping and FIG. 13 illustrates a mapping method. In this example, based on the abovementioned rotary encoder detection results, the travel route in the room and information on wall surfaces detected during travel are written in a map reserved in a memory area. The presence of an uncleaned area is determined depending on whether or not the surrounding wall surface is continuous and the areas around obstacles in the room are all continuous and the body has traveled across all areas of the room except the obstacles.

The mapping database is a two-dimensional database which allows an address to be expressed as (x, y) where (1, 1) denotes the start point in a corner of the room and (n, 0) and (0, m) denote hypothetical wall surfaces. As the body travels, the room is mapped by categorizing its subareas into several groups: uncovered areas, cleaned areas, walls and obstacles where each subarea is a unit area whose dimensions are equal to the body's dimensions, or 30 cm×30 cm.

At step S400, a start point flag is written. The start point (1, 1) is a corner of the room as shown in FIG. 13. The body turns 360 degrees (spin turn) and confirms that there is a wall surface behind and on the left of it; and the system writes a wall flag [1] for unit areas (1,0) and (0,1) and writes a wall flag [2] for an intersection of walls (0,0). At step S402, the body judges whether or not there is an obstacle ahead and at step S404, it advances by the distance equivalent to a unit area. This advance involves cleaning as mentioned above. Concretely, when an advance by a unit area distance is indicated by rotary encoder output during cleaning travel, this mapping process is performed synchronously.

On the other hand, if it is decided that there is an obstacle ahead, whether there is an obstacle in the direction of turn is judged at step S406. The body escapes from the obstacle by a combination of a 90-degree turn, an advance and a 90-degree turn. The direction of turn is alternately changed every two turns (two clockwise turns, then two counterclockwise turns). If the next turn for escape should be clockwise and there is an obstacle ahead, whether or not the body can go rightward and turn is judged. In the early stage of cleaning, on the assumption that the rightward area is uncleaned and there is no obstacle in the direction of turn, normal escape motion is done at step S408.

After the above movements, at step S410, a covered subarea flag is written for each unit area where the body has traveled. Since an area where the body has traveled (covered area) is considered to be an area which has been cleaned, a flag which represents a cleaned area is written for it. At step S412, a peripheral wall flag which represents the condition of a peripheral wall is written in each unit area. When the body moves from unit area (1,1) to unit area (1,2), it is possible to judge whether unit areas (0,1) and (2,1) are a wall or not according to the results of detection by the AF passive sensors 31R and 31L. A flag which represents a wall is written for unit area (0,1) and a flag which represents the absence of a wall and an uncovered/uncleaned area is written for unit area (2,1).

In this example, an obstacle ahead is detected at the position of unit area (1,20) and the body moves to unit area (2,20) by two 90-degree turns and an advance while the traveling direction is changed 180 degrees. At this time, a flag [4] is written for each of unit areas (0,20), (2,20), (1,21) and (2,21). For unit area (0,21), a flag which represents a wall [5] is written based on the judgment that it is an intersection of walls. A covered/cleaned area is also treated as an obstacle.

As the body advances, an obstacle on the right is detected at the positions of unit areas (3,10) and (3,11) and a flag for an obstacle [6] is written. While the body moves across unit areas (3,1) to (3,9), uncovered/uncleaned areas ahead on the right are detected and a corresponding flag is written for them. Similarly, when the body moves across unit areas (8,9) to (8,1) later, uncovered/uncleaned areas ahead on the right are detected and a corresponding flag is written for them.

When the body is at the position of unit area (4,12), an obstacle ahead is detected and an escape motion is done. Here, an obstacle flag has been written for unit area (4,11) and as it moves, an obstacle flag is written for unit area (4,11).

At step S414, whether or not there has been communication of positional data with the marker 85 is judged at the position of each covered unit area; if there has been communication with the marker 85, a flag based on the marker information is written at step S416. For example, if the user has specified a particular unit area for an escape gate using operation keys 85b to 85d of the marker 85, as the body BD passes the unit area, the infrared communication unit 83 acquires that positional data and a flag representing an escape gate is written for that unit area.

After repeated advance and escape motions, an obstacle ahead on the left is detected at the position of unit area (10,20). In this case, unit area (10,21) is judged as a continuous wall and a wall flag [4] is also written for unit area (11, 20) and a wall intersection flag [5] is written for unit area (11, 21).

As a result of repeated advance and escape motions, an obstacle ahead is detected at the position of unit area (10,1) and an obstacle in the direction of turn is also detected. Hence, whether the travel end is reached or not is judged at step S418. At the position of unit area (10,1), an obstacle ahead and a wall on the left in the traveling direction are detected [7] [8].

A primary factor which determines whether the travel end has been reached or not is the presence or absence of a unit area for which an “uncovered/uncleaned” area flag is written. If there is no unit area for which an uncovered/uncleaned area flag is written, whether or not the wall flag written at the start point is continuously repeated to go round the room is checked. If so, the room is scanned in both the X and Y directions to check for a area for which no flag is written. Unit areas for which an obstacle flag is written are considered as a continuous area like a wall and obstacle detection is thus finished.

If the cleaning travel end has not been reached, an uncovered area is detected at step S420 and the body moves to the start point of that uncovered area at step S422 and the above process is repeated. When it is finally decided that the cleaning travel end has been reached, mapping is completed. Upon completion of mapping, the walls and covered areas of the room are clearly indicated and this is used as geographical information.

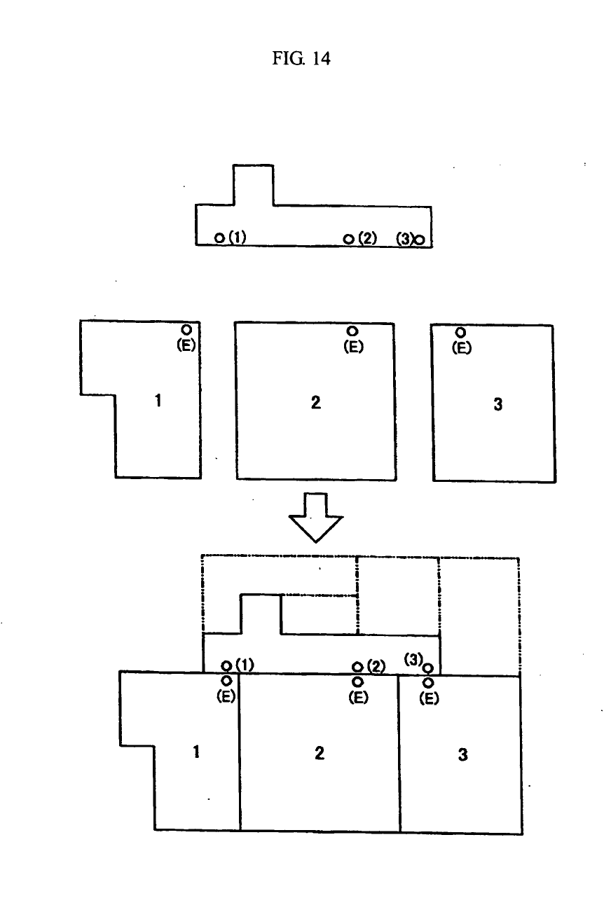

All rooms and halls should be mapped with the abovementioned procedure and entrances to rooms in halls should be marked via the marker 85. FIG. 14 shows a method of interlinking geographical information on rooms and halls. All rooms are numbered (1-3) and entrances/exits (E) and approaches to rooms from halls (1-3) are marked so that geographical information on rooms is two-dimensionally interlinked.

(3) Gas Detection Process

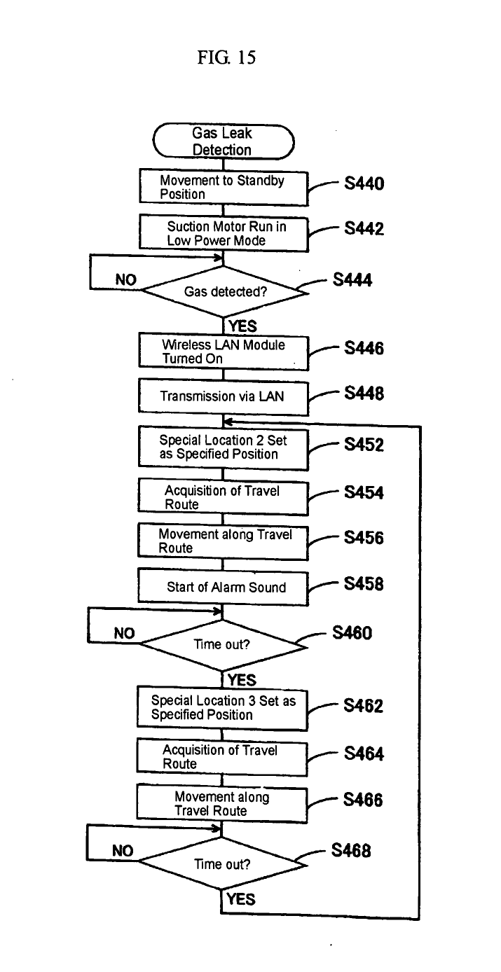

FIG. 15 shows a process of detecting a gas leak and generating an alarm sound.

This self-propelled cleaner enables the user to choose an operation mode through the liquid crystal display panel 15b; when the user chooses a gas leak detection mode using an operation switch 15a, the gas detection process as shown in FIG. 15 is executed.

Prior to starting the gas leak detection process, the cleaner body must move to special location 1 as a standby position for gas leak detection at step S440, so the system calculates a travel route from the present position to special location 1 and the body moves along the travel route. This movement will be described later.

After movement to special location 1, at step S442 the system orders the motor driver 56 to drive the suction motor 55 for driving the suction fan in the low power mode. This allows the self-propelled cleaner, in the standby position specified as special location 1 via the marker 85, to drive the suction fan in the low power mode to start suction of ambient air into it through its suction hole. Then, at step S444, the cleaner in the standby position continues to detect for a gas leak.

In this embodiment, the suction fan is activated in the standby position which the self-propelled cleaner can access. Since it runs on the floor surface, it can detect a leak of gas which is heavier than air. In order to detect a leak of lighter-than-air gas, the following two methods are available.

One method is that a communication pipe is laid from the floor surface to the ceiling in the standby position and air near the ceiling is led through a floor side opening in the communication pipe into the cleaner by the suction fan. In the standby position, the communication pipe has openings near the wall surface and a suction hole is made on the side of the body BD in a way to face one of the openings and the suction hole is almost in contact with the opening of the communication pipe to suck air. When a charge station is provided to charge the battery in a non-contact manner, provision of a means to make one end of the pipe open to the bottom of the body BD makes it possible to detect for a leak of gas in the air from the ceiling while it stands by and its battery is being charged.

As the suction fan is activated, it works hard to take in ambient air, thus facilitating gas leak detection. However, obviously gas can be detected without activating the suction fan. In this case, the gas sensor 82 need not be installed in the suction channel.

It is also possible to use the gas sensor 82 which is separate from the body. If it is a separate unit, it may be designed to send the result of detection as an infrared signal which the infrared communication unit 83 can receive. In this case, its location can be changed more freely in a way that it can be installed on the ceiling for detection of lighter-than-air gas or near the floor for detection of heavier-than-air gas. Alternatively, the separate unit may be designed to send the result of detection through a wireless LAN.

At step S444, when the result of detection by the gas sensor 82 indicates no gas leak, the system continues detection; on the other hand, if gas is detected, the system prepares the wireless LAN unit 70 to start wireless LAN communication at step S446. The wireless LAN module 71 is usually off for power saving and turned on when necessary. Therefore, it is turned on before starting communication and at step S448, it transmits the result of detection through the wireless LAN. The result of detection is transmitted to a predetermined address by e-mail. A means to select where to transmit it through the wireless LAN should be provided; the user previously chooses a destination address using the liquid crystal display panel 15b and the operation switches 15a and if a gas leak is detected, a text message to notify of gas leak detection is transmitted to the chosen address by e-mail. If the system is preset so as to execute the gas leak detection process while no one is at home, the user can know the result of detection away from home by previously choosing a mail address which is usable away from home.

At step S452, in order to notify a person at home of a gas leak, in preparation for move to special location 2 specified as the first alarm position, special location 2 is preset as a specified position so that the system calculates a travel route to that specified position at step S454.

When geographical information is completed as described above, it is possible to find the travel route from the present position to the specified position. To obtain the travel route, a known labyrinth solution method may be used. For example, according to the right hand method, when you advance with your hand always on a wall surface along the advance direction, you can finally reach from the entrance to the goal. Then, redundant paths are deleted sequentially. For example, return paths after 180-degree turns are deleted sequentially. Also, a subarea of U turn is found and subareas as a return path after the U turn are skipped unless there is an obstacle. Instead of an automatic travel route calculation like this, an interface which shows the user a travel route may be provided. After the travel route is calculated in this way, the body moves along the travel route at step S456. Movement to the standby position at step S440 is carried out in the same way as above.

After completion of the movement, the alarm sounder 84 generates an alarm sound at S458. The alarm sound continues for a fixed time period. Therefore, at step S460, the system judges whether the fixed time period has elapsed or not and if not, waits until times runs out.

Since the mapping process requires a high functional ability, the capacity of the CPU 11 or RAM 13 has to be increased.

By contrast, movement to the standby position can be achieved using only the function of moving the body along a wall and the marker 85. For movement along the wall, first the body BD advances based on the results of detection by the AF passive sensors 31FM, 31FR, and 31FL until a wall surface ahead is detected, and makes a spin-turn just before the wall surface. The body BD “advances” when the same speed, same direction and same amount of rotation are specified for both the left and right driving wheel motors 42R and 42L, while the body BD makes a “spin-turn” when the same speed, different directions and the same amount of rotation are specified for the left and right driving wheel motors 42R and 42L. For the spin-turn, the system receives the results of detection by the AF passive sensors 31R and 31L and the body BD stops moving when the distance to the wall surface beside it is shortest. When the distance to the wall surface beside the body BD is shortest, the body BD is thought to be almost parallel to the wall surface. As it advances from that position, it should move parallel to the wall surface. During this movement, the system continues to monitor the distance from the wall surface and, if it detects any change in the distance, increases or decreases the amount of rotation of the driving wheel motors 42R and 42L to correct the moving direction. There are two types of corners at which the body BD turns: in one type of corner, it touches a corner wall and in the other type of corner, it passes over the corner. When a wall surface ahead is detected, the body BD is about to touch a corner wall; just before touching it, it makes a spin-turn and restarts moving forward parallel to the wall surface. On the other hand, when the system no longer detects a wall beside after it continuously detects it, it knows that it has passed over the wall corner; and then it makes a 90-degree spin-turn to become parallel to the other wall surface, and as it detects the wall surface beside it, it further moves parallel to the wall surface.

Movement along a wall is done as described above. During such movement, the system monitors the result of detection by the infrared communication unit 83 to check whether it receives positional data as an infrared signal from the marker 85.

When the marker indicates special location 2 as an alarm position, the alarm sounder 84 generates an alarm sound in that position like at step S458.

The hardware/software configuration required for this travel control method, which combines control of movement along a wall and the use of the marker, is simple and less costly and thus very feasible. In addition, since there is no risk of false positional recognition which could occur in travel based on geographical information obtained by mapping because of inadequate accuracy, the reliability is high. However, in travel based on such geographical information, the travel distance is minimized or the travel route is shortest.

There is a possibility that no person is present at a place specified as an alarm position, so special location 3 is preset as a secondary alarm position. At step S460, when time runs out, the body moves to special location 3. The system sets special location 3 as a specified position at step S462 and calculates the travel route from the present position to the specified position at step S464 and moves along the travel route at step S466.

Even in this case, since the method of controlling movement along a wall is valid, the body moves along a wall until a marker 85 as an indicator for special location 3 is found.

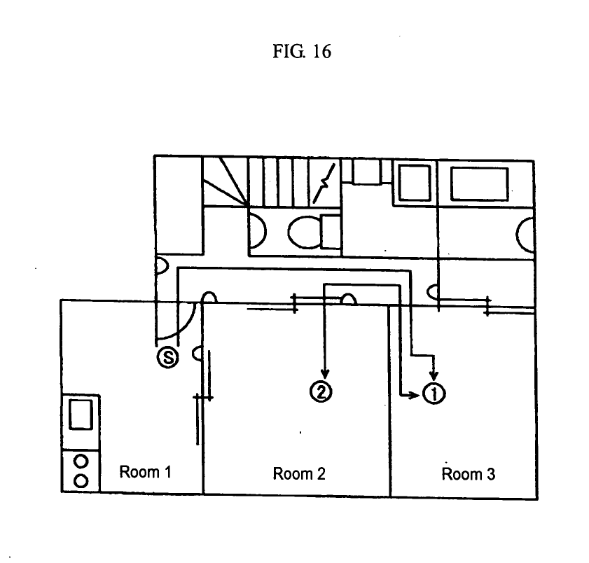

After movement to the second alarm position, at step S468 the system waits there until time runs out. After time runs out, the system again takes step S452 and subsequent steps to return to the first alarm position. FIG. 16 shows a travel route where the kitchen is specified as the standby position, room 3 as the first alarm position and room 2 as the second alarm position.

In this embodiment, the body shuttles between the first and second positions and generates an alarm sound in each position as described above. Alternatively, the system may be programmed so that the body moves to a third alarm position, or so that the alarming method differs depending on whether or not someone is at home. For example, when no one is at home, an alarm message may be sent through the wireless LAN to more than one destination or the body may move to the front door so that neighbors can hear the alarm sound. Another possible approach is to acquire the present time and specify a bedroom as the first alarm position for nighttime and a living room as the first alarm position for daytime.

As mentioned above, after movement to the standby position at step S440, the system judges whether there is a gas leak, based on the result of detection by the gas sensor 82. If there is a gas leak, the system transmits a text message by e-mail at step S448 to notify a predetermined destination of the gas leak and calculates the travel route to the preset first alarm position at steps S452 and S454; then the body moves along the travel route at step S456 and the alarm sounder 84 generates an alarm sound at step S458. After a preset time period, the system takes a similar procedure at steps S462 to 466 to move the body to the preset second alarm position and continues generating an alarm sound. Then, the body continues reciprocating between the first and second alarm positions.

1. A self-propelled cleaner having a body with a cleaning mechanism with a suction motor for vacuuming up dust, and a drive mechanism with driving wheels at the left and right sides of the body whose rotation can be individually controlled for steering and driving the cleaner, comprising:
a mapping processor which acquires and stores geographical information on a room to be cleaned during traveling around the room for cleaning it and acquires positional data on an alarm position, during traveling around the room, from a marker installed in a given place in the room which outputs positional data on a previously specified location, and adds it to the geographical information;
a gas sensor which detects a gas leak;
an alarm sounder which generates an alarm sound;
a wireless LAN communication device which can transmit given information to the outside through a wireless LAN;
a travel route calculation processor which calculates a travel route from the present position to the specified location; and
a gas leak alarm control processor which acquires the result of detection by the gas sensor in a predetermined standby position and upon detection of a gas leak, enables the travel route calculation processor to calculate a travel route and controls the drive mechanism to move the cleaner along the travel route to the specified location, allows the alarm sounder to generate an alarm sound through a speaker and sends an alarm message to the outside through the wireless LAN communication device.

2. A self-propelled cleaner having a body with a cleaning mechanism, and a drive mechanism capable of steering and driving the cleaner, comprising:
a gas sensor which detects a gas leak;
an alarm sounder which generates an alarm sound; and
a gas leak alarm control processor which acquires the result of detection by the gas sensor in a predetermined standby position and upon detection of gas, controls the drive mechanism to move the cleaner to a predetermined alarm position and enable the alarm sounder to generate an alarm sound in that position.

3. The self-propelled cleaner according to claim 2, wherein it has a wireless LAN communication device which can transmit given information to the outside through a wireless LAN and the alarm sounder not only generates a voice alarm but also sends an alarm message to the outside through the wireless LAN communication device.

4. The self-propelled cleaner according to claim 2, wherein it has a suction motor for vacuuming up dust and the gas sensor lies in the suction channel and the gas leak alarm control processor drives the suction motor to take in ambient air and allow the gas sensor to detect for a gas leak.

5. The self-propelled cleaner according to claim 4, wherein a communication pipe with openings at both the ceiling and floor sides is installed in a room and an opening in the suction channel of the suction motor can communicate with the floor side opening in the communication pipe.

6. The self-propelled cleaner according to claim 2, wherein the gas sensor is separate from the body and notifies the gas leak alarm control processor of the result of detection wirelessly.

7. The self-propelled cleaner according to claim 2, wherein the gas leak alarm control processor comprises:
a mapping processor which generates and stores geographical information on a room during traveling around the room by self-propulsion, and acquires, from a marker installed in a given place in the room which outputs positional data on a previously specified location, the positional data during traveling around the room and adds it to the geographical information;
a travel route calculation processor which calculates a travel route from the present position to the specified location; and
a movement control processor which enables the travel route calculation processor to calculate a travel route and controls the drive mechanism to move the cleaner along the travel route to the specified location.

8. The self-propelled cleaner according to claim 2, wherein the gas leak alarm control processor has, on the body, a wall sensor for detecting a surrounding wall surface, and while receiving the result of detection by the wall sensor, can control the drive mechanism to move the cleaner along the wall, and acquire positional data from a marker installed along the wall which outputs positional data, and judge whether movement to the alarm position has been completed or not.

9. The self-propelled cleaner according to claim 2, wherein the gas leak alarm control processor has an operation panel unit composed of a liquid crystal display panel for selection of a gas leak detection mode and operation switches.

10. The self-propelled cleaner according to claim 2, wherein, prior to starting a gas leak detection process, the gas leak alarm control processor calculates a travel route from the present position to a special location as the standby position for gas leak detection and lets the body move along the travel route; after movement to the special location, it orders a motor driver to drive the suction motor for driving a suction fan in the low power mode; then in the standby position specified as a special location, it drives the suction fan in the low power mode to take in ambient air through a suction hole and detect for a gas leak continuously.
